(19) United States
(12) Patent Application Publication
(10) Pub. No.: US 2005/0024855 A1
(43) Pub. Date: Feb. 3, 2005

(54) Illumina

(76) Inventors: Philip Padilla Ruiz, Kent, WA (US); Glenn Noel Padilla Ruiz, Kent, WA (US)

Correspondence Address: R REAMS GOODLOE, JR. & R. REAMS GOODLOE, P.S., 24722 104TH. AVENUE S.E., SUITE 102, KENT, WA, 98030-5322, US

(21) Appl. No.: 10/814,038

(22) Filed: Aug. 13, 2004

Related U.S. Application Data
(60) Provisional application No. 60/466,771, filed on May 1, 2003.

(51) Int. Cl. F21V 8/00

(52) U.S. Cl. 362/145

(57) ABSTRACT

Illuminated building address signs. A letter and number display panel system having a plurality of translucent display panels is provided. An electrical supply unit may be provided, with a power adaptor as necessary. In one embodiment, an ambient light photo sensor and controller switches the unit on at the onset of darkness. The display panels contain a multi-level light source and an identification symbol which is illuminated by the multi-level light source. The translucent display panels contain electro luminescent identification symbols of numbers and letters. The display panel system may include controller operation for display mode wherein the display panels are powered in a flashing configuration for emergency purposes.

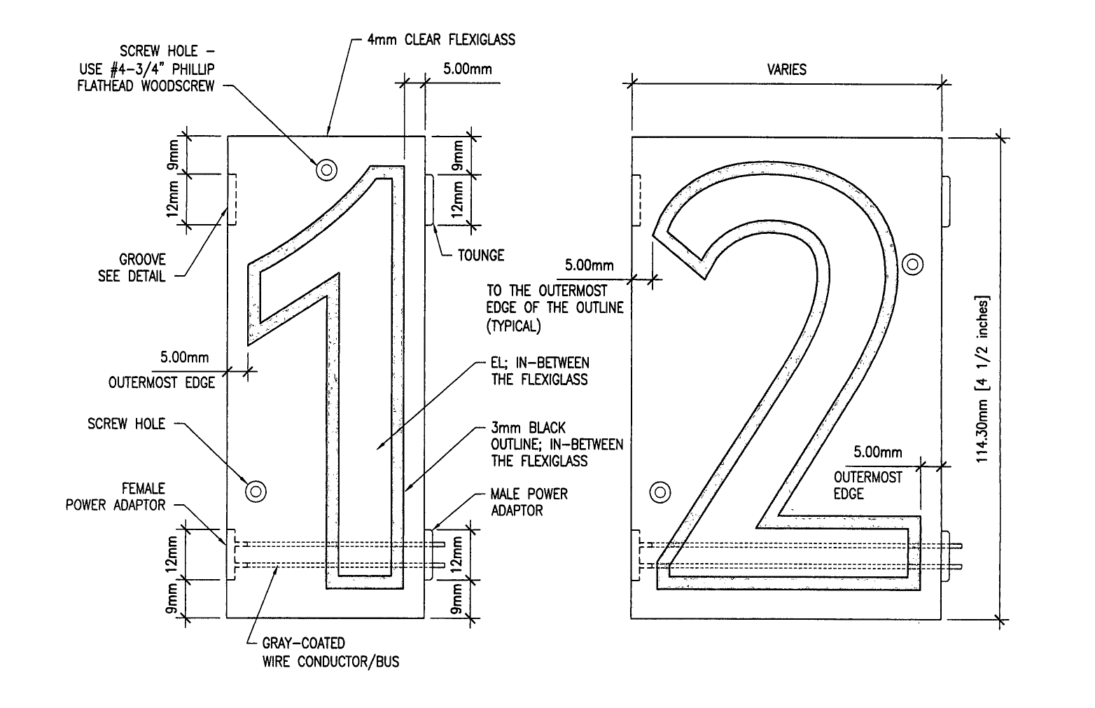

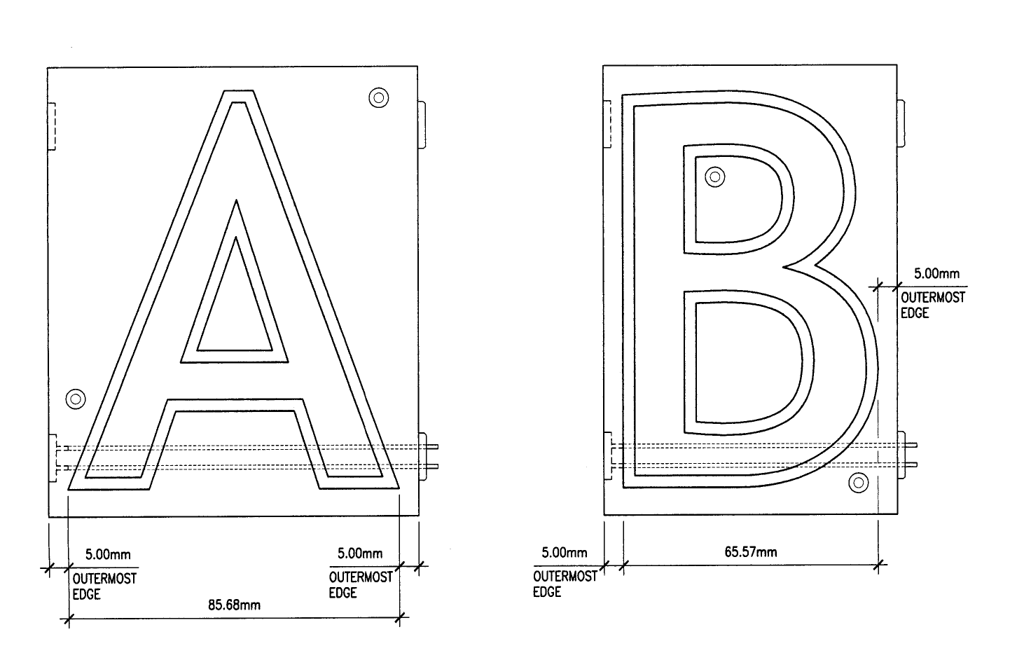

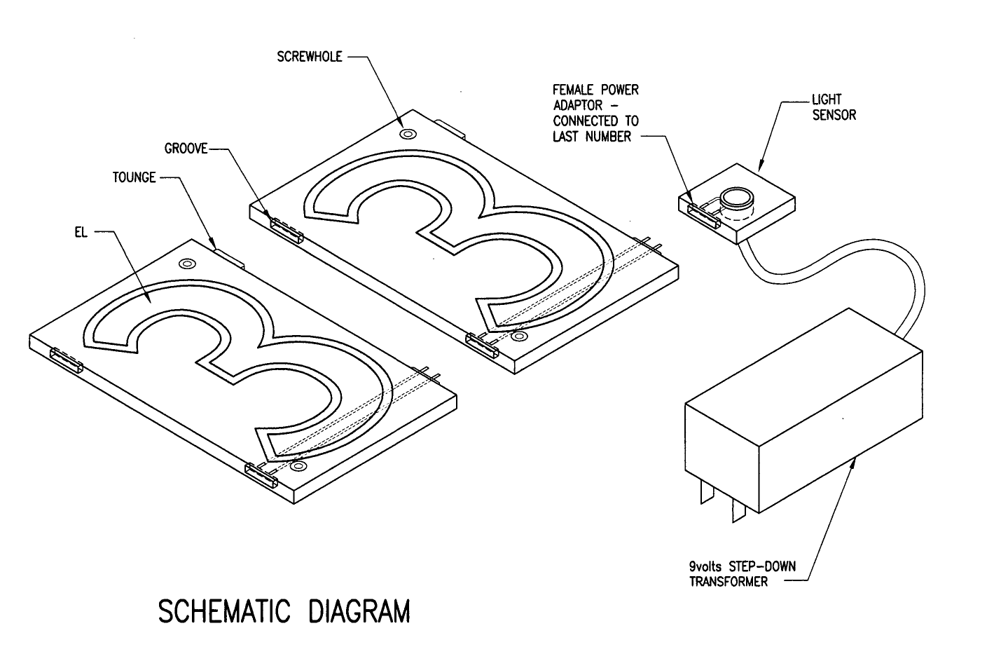

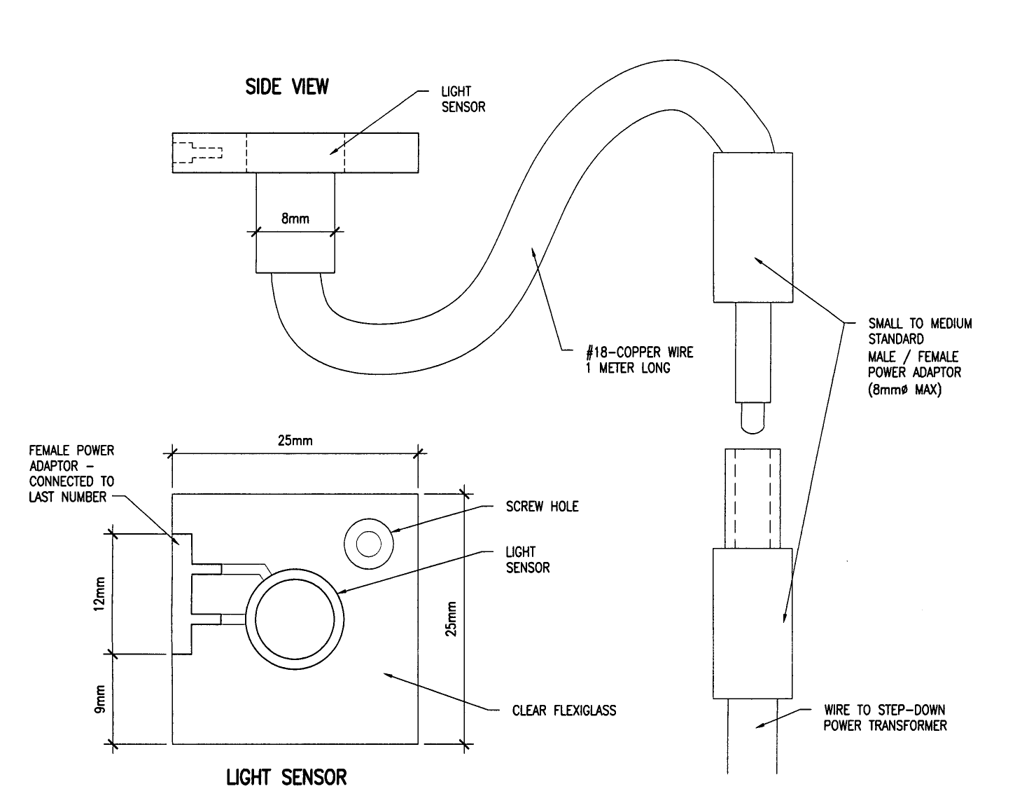

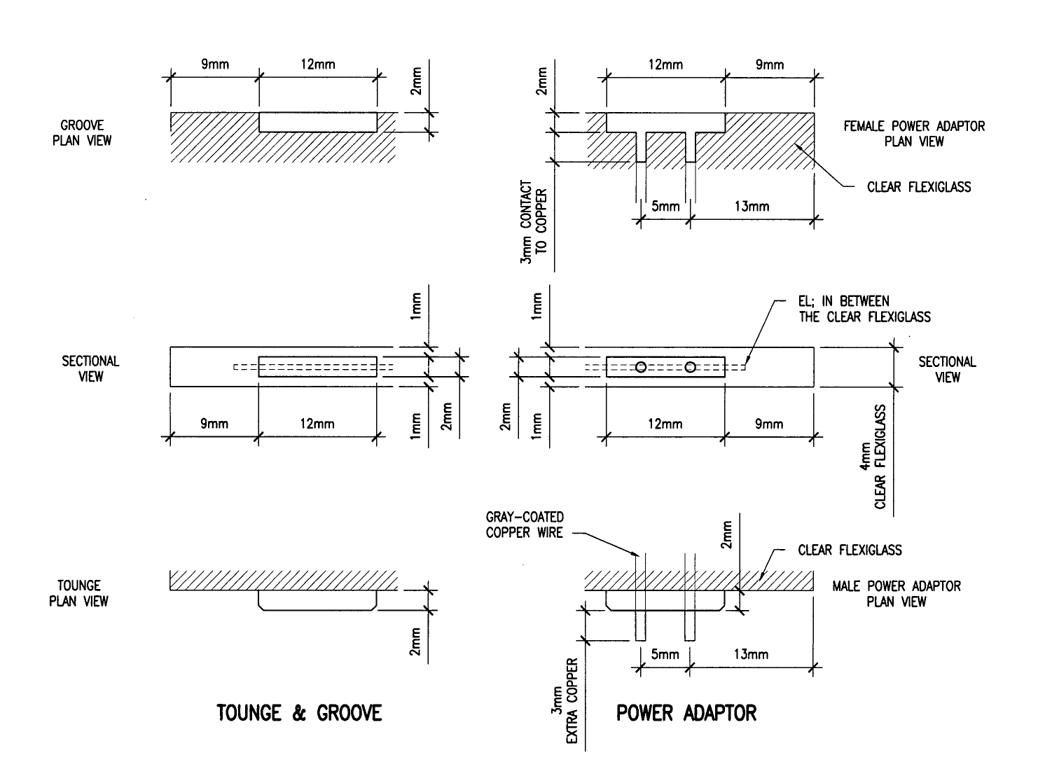

### AIM

To provide easy to read lit numbers and letters using electroluminescent (EL) lites.

### FUNCTION/PURPOSE

Illumina e-lites are electroluminescent (EL) equipped numbers and letters that enhance the ability to locate addresses and street names. Illumina e-lites definitely will assist emergency medical technicians (EMT's), firefighters, law enforcers, delivery personnel and the general public by providing better visual illumination of addresses, street names and traffic signs in foggy and hazy weather, in dark and unlit areas.

### DESCRIPTION(S)

Version 1:
Power supply—9V DC
Numbers 0 to 9
Letters A to Z
Weather resistant
Easy installation
Optional photo sensor—dusk to dawn
Optional flasher for 911 response

Version 2:
Power supply—solar power
Numbers 0 to 9
Letters A to Z
Weather resistant
Easy installation
Optional photo sensor—dusk to dawn
Optional flasher for 911 response

Advantages:
Better visual illumination at night, unlit areas, hazy and foggy weather.
In cases of emergency situations, it makes it easier for EMT's, firefighters, law enforcers and the like to find and read addresses, thereby saving valuable time and eventual saving lives.
Optional phone hook-up to 911 response. Home address flashes when 911 is dialed from home phone, alerting emergency personnel that; “this is the house.”
Even helpful for delivery personnel, friends and relatives coming to visit, they don't need to carry a flashlight with them or shine their car headlights at the house or knocking at every door asking for the right address.
Does not emit heat (low operating temperature)
Cool to touch
Optional photo sensor to switch on at dusk and switches off at dawn
Pleasing to the eye (not glaring)
Energy efficient (low power consumption), low operating cost
Uniform lighting
Easily connects with each other (you can change numbers and letters individually)
Durable and weather resistant construction
Adds beauty to homes and business establishments
Comes in different colors

Basic sizes for the numbers are 4 inches in height, letters are 2 inches in height for residential use and 12 inches and 10 inches respectively, for commercial use. However, we can meet sizes based on specifications by homeowner(s) and/or builders and State and/or Federal specifications for street signs and road signs. Width may vary for numbers and letters.

Who Would Use the System?

Homeowners, home and commercial builders, businesses and government establishments.

Who Benefits With the Use of the System?

Emergency personnel, law enforcers, firefighters, homeowners, business establishment personnel, delivery people, friends, relatives and just about anyone.

Goal:

Our goal is to be able to assist the emergency medical technicians, firefighters, law enforcers during emergencies with better visual illumination of addresses and the general public during foggy and hazy conditions and in dark and unlit areas.

1. An apparatus for identifying a house comprising:
a plurality of translucent display panels, each of said display panels having a light source therein and an identification symbol thereon, said identification symbol illuminated by the light source,
said translucent display panels further comprising a male interlocking connector portion and a female interlocking connector portion, said interlocking connector portions in adjacent display panels of said plurality of translucent display panels configured for detachable interfitting mating engagement, said male and female interlocking connector portions comprising power supply wiring for supply of power to said light source within each of said display panels.

2. The apparatus as set forth in claim 1, further comprising an electrical power supply unit, said power supply unit configured to supply a desired voltage electrical power supply to said plurality of translucent display panels.

3. The apparatus as set forth in claim 1, further comprising a power adaptor, said power adaptor configured for interlocking engagement with one of said interlocking connector portions on one of said translucent display panels, said power adapter configured for transmitting electrical power from said electrical power supply to one of said interlocking connector portions.

4. The apparatus as set forth in claim 2, wherein said electrical power supply comprises a transformer.

5. The apparatus as set forth in claim 4, wherein said transformer supplies power at approximately 9 volts.

6. The apparatus as set forth in claim 1,wherein said display panels further comprise one or more screw through apertures defined by interior edge wall portions.

7. The apparatus as set forth in claim 2, wherein said display panels comprise first and second sidewall portions, and wherein said interlocking connector portions are configured as complementary receptacle grooves and protruding plugs.

8. The apparatus as set forth in claim 7, wherein said receptacle grooves are provided in said first sidewall, and said plugs are provided protruding from said second sidewall.

9. The apparatus as set forth in claim 8, wherein adjacent display panels are secured in interfitting mating engagement by complementary tongue and groove features in adjacent first and second sidewalls of adjacent display panels.

10. The apparatus as set forth in claim 1, wherein said display units comprise multi-level light sources, said multi-level light source configured for operation in a normal, low intensity lighting mode, and an emergency, high intensity lighting mode.

11. The apparatus as set forth in claim 1, further comprising an ambient light photo sensor and a controller, said ambient light sensor adapted to sense low light conditions and to act, through said controller, to turn on said light sources in said plurality of display panels.

12. The apparatus as set forth in claim 1, wherein said translucent display panels comprise electroluminescent identification symbols.

13. The apparatus as set forth in claim 12, wherein said identification symbols comprise numbers.

14. The apparatus as set forth in claim 12, wherein said identification symbols comprise letters.

15. The apparatus as set forth in claim 10, wherein said controller further comprises an emergency display mode, and wherein said one or more display panels are powered in a flashing configuration during said emergency display mode.
